(19) United States
(12) Patent Application Publication
(10) Pub. No.: US 2002/0133247 A1
(43) Pub. Date: Sep. 19, 2002

(54) System and method for seamlessly switching between media streams

(76) Inventors: Robert D. Smith, Heathrow, FL (US); Daniel S. Schiappa, Great Falls, VA (US); Robert D. McDonald, Great Falls, VA (US)

Correspondence Address: COOLEY GODWARD LLP, ATTN: PATENT GROUP, 11951 FREEDOM DRIVE, SUITE 1700, ONE FREEDOM SQUARE- RESTON TOWN CENTER, RESTON, VA, 20190-5061, US

(21) Appl. No.: 09/987,207

(22) Filed: Nov. 13, 2001

Related U.S. Application Data
(60) Provisional application No. 60/247,381, filed on Nov. 11, 2000.

(51) Int. Cl. G06F 17/00; H04L 5/22; H04Q 11/00; H04L 12/50

(52) U.S. Cl. 700/94; 370/299; 370/360

(57) ABSTRACT

A system and method for seamlessly switching between multiple media streams of multimedia content is disclosed. A media server transmits a first media stream to a media client and a media player plays it to a user. At some point, a request to play a second media stream at the media client is detected. A media stream buffer is provided that buffers one or both of the media streams. The media stream buffer enables the media player to continue to play at least one of the media streams while switching between the first media stream and the second media stream. Since the media player continues to play at least one of the media streams to the user without interruption, the switch from the first media stream to the second media stream is thus affected seamlessly.

### CROSS-REFERENCE TO RELATED APPLICATIONS

The present application is related to the following co-pending utility applications, each of which is incorporated herein by reference: U.S. application Ser. No. 09/635,771, filed Aug. 11, 2000, entitled “System And Method for Storing and Retrieving Video Images;” U.S. application Ser. No. 09/635,770, filed Aug. 11, 2000, entitled “System and Method for Delivering Video Images;” U.S. application Ser. No. 09/635,769, filed Aug. 11, 2000, entitled “System and Method for Video Image Ordering, Production and Fulfillment;” U.S. application Ser. No. 09/635,767, filed Aug. 11, 2000, entitled “System and Method for Dynamically Updating Delivered Video Images,” and U.S. application Ser. No. 09/635,768, filed Aug. 11, 2000, entitled “System and Method for Providing a Video Shopping Agent.”

### BACKGROUND OF THE INVENTION

1. Field of the Invention

The present invention relates generally to digital media, and more particularly, to a network-based system and method for streaming and playing multiple media streams.

2. Discussion of the Related Art

The attraction of the Internet has caused a significant shift in the delivery of traditional broadcast media content. Internet content providers offer users access to multimedia content online, as an alternative to traditional media such as television, radio, prerecorded video, and audio. Online multimedia content offers users a broader selection and more convenient delivery than traditional broadcast media.

Users at client devices such as personal computers (“PCs”), personal digital assistants (“PDAs”), etc., access and play multimedia content with media players, such as Microsoft® Windows Media Player®, Progressive Networks® RealPlayer®, Apple Computer Corporation®, QuickTime® video player, etc. Traditionally, users played multimedia content by accessing entire multimedia content files from removable media or downloading them via a network. Downloading and storing entire multimedia content files, however, consume valuable network and storage resources. Media streaming was developed to address these problems. Media streaming is a technique for transferring multimedia content data from a server to a client device and processing it at the client device as a steady and continuous media stream.

Media streaming poses a number of advantages. Live events, such as concerts and sports events may be streamed to client devices as they occur, rather than creating a monolithic multimedia content file once the event has ended. Client devices may begin playing streamed multimedia content as it is received from the server, rather than waiting to download an entire multimedia content file. Because the media stream is played as it is received, users can cancel playing the media stream without storing or downloading the entire multimedia content file. Because of the number of advantages, media streaming has become a very popular way to deliver multimedia content.

Because of an almost infinite amount of multimedia content, internet content providers seek new ways to exploit media streaming technology. For example, sporting events are often covered using multiple video cameras. Often, a user may prefer one camera to another because, for example, one camera is dedicated to a particular player or portion of the sporting event. The ability to switch between multiple streams would allow the user to choose the preferred camera. Other situations in which a user may wish to switch between media streams include, for example, multiple cameras and/or sound sources in live broadcasts, multiple audio tracks in radio or video broadcasts, special features such as biographical segments accompanying sports, entertainment, and educational programming. Unfortunately, problems with switching between or among multiple media streams prevent internet content providers from offering media stream switching to users.

One problem in particular is an unacceptably long delay and its accompanying discontinuity in switching between different media streams, often leaving the user to stare at a blank or frozen media player for several seconds. This is due to the time it takes for a media player to stop playing a first media stream, request a second media stream from the server, wait to receive the second media stream, and begin playback of the second media stream.

Accordingly, what is needed is an improved mechanism for media streaming. In particular, what is needed is a system and method for switching between multiple media streams that provide the user with continuous playback of multimedia content.

### SUMMARY OF THE INVENTION

The present invention addresses the drawbacks of conventional multimedia content streaming technology by providing a system and method for seamlessly switching between multiple media streams. According to the present invention, a media server transmits multimedia content data as a first media stream over a network to a media client. The media client receives the first media stream, and a media player plays it to a user. At some point, a request to play a second media stream at the media client is detected.

One feature of the present invention enables the media player to switch between the first media stream and the second media stream without interruption. One aspect of this feature is that a media stream buffer is provided that buffers one or both of the media streams. The media stream buffer enables the media player to continue to play at least one of the media streams while switching between the first media stream and the second media stream.

Another feature of the present invention provides for seamless switching between a first media player playing the first media stream and a second media player playing the second media stream. One aspect of this feature is that the second media player begins receiving the second media stream while the first media player plays the first media stream. A method is provided for switching from the first media player to the second media player so that the user experiences uninterrupted play of the media streams.

The features and advantages of the invention will become apparent from the following drawings and description.

### BRIEF DESCRIPTION OF THE DRAWINGS

The present invention is described with reference to the accompanying drawings. In the drawings, like reference numbers indicate identical or functionally similar elements. Additionally, the left-most digit(s) of a reference number identifies the drawing in which the reference number first appears.

FIG. 1 illustrates a media streaming network.

FIG. 2 illustrates an exemplary embodiment of media client.

FIG. 3 illustrates an alternate embodiment of the present invention.

FIG. 4 is a flow chart illustrating a process according to the present invention.

FIG. 5 is a flow chart illustrating a process according to the present invention.

### DETAILED DESCRIPTION

The present invention is discussed below with respect to various explanatory embodiments. While specific implementations are discussed, it should be understood that this is done for illustrative purposes only. Various features of the present invention may be extended to other applications and embodiments, as would be apparent.

Media streaming is a very popular method of delivering multimedia content over a network. Various types of multimedia content can be delivered via media streaming including, but not limited to, video, audio, graphics, and text. Through media streaming, users may listen to audio programming, such as internet radio; watch video clips, such as news clips and movies; and receive animation and graphics presentations. Media players that support streaming abound, and competition among various media streaming formats is fierce. In the future, almost all media, including video and audio, may be delivered via media streaming over a network rather than broadcast, as it is today.

There are a number reasons for the broad appeal of network media streaming. Users may access a wider variety of programming rather than be limited to whatever programming that happens to be broadcast. Additionally, users may access programming “on demand,” rather than scheduling their lives around the occurrence or recording of a broadcast. Delivery of multimedia content via a network also provides users with greater variety. Because online multimedia content is not limited to a number of daily time slots or broadcast channels, internet content providers can provide an almost infinite selection of programming.

Because of the enormous selection of multimedia content, internet content providers have attempted to provide users with a way to switch between media streams. Switching between multiple media streams allows a user to view separate sources of multimedia content consecutively. For example, through media stream switching, a user may choose between multiple cameras positioned at various locations and angles during a sporting event, select different cameras through which to view a concert, etc. Unfortunately, conventional media stream switching technology results in unacceptably long delays and their associated discontinuities between playing one media stream and playing another.

The present invention is primarily directed to a mechanism that provides seamless switching between multiple sources of multimedia content. In particular, the present invention provides a system and method for seamlessly switching between multiple media streams played at a media client.

Before discussing the invention in further detail, several terms used herein are defined. Multimedia content is the integrated presentation of text, graphics, video, animation, and sound, alone or in any combination. Multimedia content is stored as multimedia content data in a multimedia content file. Media streaming is a well-known technique for transferring multimedia content data over a network. In media streaming, a media server transfers multimedia content data, such as digital audio, digital video, or other digital content, as a media stream, to a media client over a network such that that particular media stream can be processed as a steady and continuous stream. For example, Windows® Media Format from Microsoft® is optimized for streaming and playing back audio, video, and script data. Preferably, a media server stores the multimedia content data as multimedia content files, and streams the files over a network to a media client. MP3 files, MPEG files, AVI files, QuickTime video files, .WAV files, Windows Media Player files, etc., are examples of multimedia content files.

A media client is any device capable of playing a media stream. Examples of media clients are devices such as Personal Computers (“PCs”), Personal Digital Assistants (“PDAs”), internet enabled wireless telephones, etc. Preferably, once a media stream is received at a media client, the media stream is played using a media player. Media players are widely used software and firmware programs that play media streams. Examples of such media players are Microsoft® Windows Media Player®, Progressive Networks®, RealPlayer®, Apple Computer Corporation®, QuickTime® video player, etc.

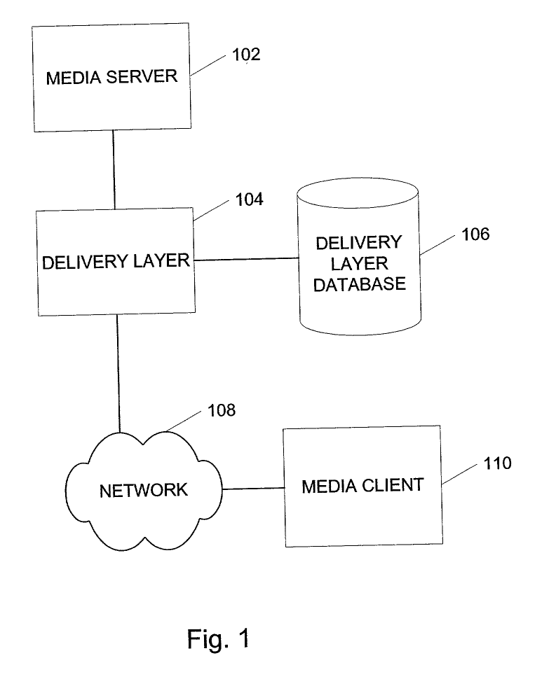

The present invention is now described with reference to FIG. 1. FIG. 1 illustrates a media streaming network 100 for seamlessly switching between multiple media streams. Media streaming network 100 includes a media server 102, a delivery layer 104, a delivery layer database 106, a network 108, and a media client 110. Generally, media server 102, delivery layer 104, and delivery layer database 106, work together to provide a media stream to media client 110 via network 108. In a preferred embodiment of the present invention, delivery layer 104 and delivery layer database 106 preferably include a dynamic delivery layer as discussed in U.S. application Ser. No. 09/635,770, filed Aug. 11, 2000, entitled “System and Method for Delivering Video Images;” incorporated herein by reference in its entirety.

It should be noted that media server 102, delivery layer 104, delivery layer database 106, and network 108 are depicted as logical representations of system elements. As such, each logical representation may correspond to a number of physical components. For example, media server 102 may be implemented as a number of media servers at one physical location to provide for scalability according to the media serving load, as would be apparent, or as a number of media servers at multiple physical locations providing various types of multimedia content.

Initially, a user at media client 110 desires to play multimedia content. The user uses media client 110 to access media server 102 via network 108. Once the user identifies some desired multimedia content at media server 102, media client 110 generates a request for the media stream associated with the multimedia content. Preferably, the request includes a network address of the content and information identifying the particular media stream desired.

In the example of media streaming network 100, media client 110 sends the request via network 108 to delivery layer 104. In a preferred embodiment of the present invention, delivery layer 104 determines the configuration of media client 110 and optimizes the media stream for delivery. Examples of configuration information read from media client 110 are the software and hardware platform of media client 110, the media client operating system, media player type and version, network connection speed, etc. Delivery layer 104 reads configuration information from media client 110 and combines it with information in the request. This combination is referenced against delivery layer database 106 to determine the particular multimedia content file to be streamed to media client 110. Delivery layer 104 then submits a request to media server 102 to transmit the media stream to media client 110. Media server 102 responds to the request from delivery layer 104 by streaming the multimedia content file, as a media stream through delivery layer 104 to media client 110.

In an alternate embodiment of the present invention, the request from media client 110 is submitted directly to media server 102, and identifies a particular media stream. In this embodiment, media server 102 transmits the media stream to media client 110, bypassing delivery layer 104. Media server 102 may include a number of multimedia content files and media streaming server software in order to support different media players and media streaming formats. Media client 110 plays the media stream once it is received via network 108.

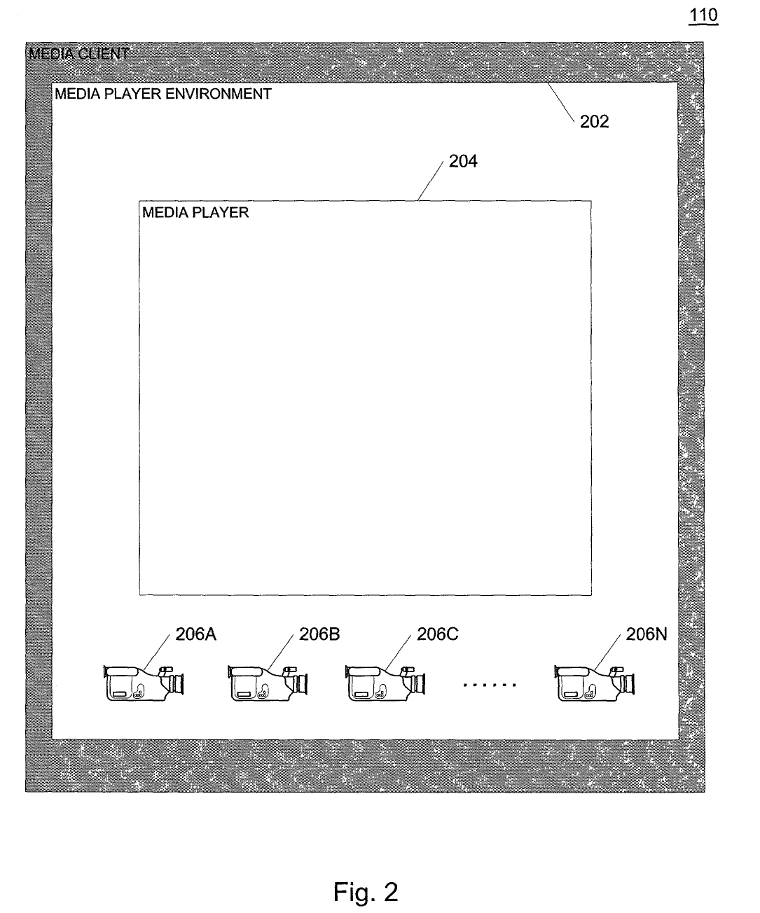

FIG. 2 illustrates an exemplary embodiment of media client 110. Media client 110 includes a media player environment 202, a media player 204, and one or more media stream selectors 206 (illustrated as media stream selectors 206A-206N). The present invention contemplates various configurations of media client 110, such as media clients implemented in hardware, firmware, embedded devices, etc., and that media client 110 is shown for illustrative purposes only.

Media client 110 provides a hardware and software platform by which users access media streams, and provides a system for seamlessly switching between multiple media streams. Generally, media player 204, operating within media player environment 202, plays a media stream to the user. Using media stream selectors 206, the user may select between a first media stream and a second media stream, thereby switching the media streams being played on media player 204. Given present bandwidth constraints on network 108, in order to enable media stream switching, the first media stream, the second media stream, or both are buffered at media client 110. Buffering a media stream allows media player 204 to play the buffered media stream even in the absence of the media stream itself. However, the present invention contemplates switching between media streams without buffering either of them as bandwidth constraints are alleviated.

A user initiates the process of playing a media stream by accessing multimedia content via network 108 as discussed above. In the preferred embodiment, the user accesses network 108 via media player environment 202. Media player environment 202 allows the user to access various network resources, such as file servers, web sites, media streams, etc. Examples of media player environment 202 include web browsers, such as Microsoft® Internet Explorer®, or Netscape® Navigator®. As would be apparent, however, media player environment 202 may include any software or hardware that allows a user to access network 108. In a preferred embodiment, network 108 is the World Wide Web (“WWW”), but it should be noted that network 108 may represent any network that includes multimedia content, such as a local area network, a wireless network, an intranet, etc. It should also be noted that the present invention contemplates having one or more of the media streams stored locally at the client device.

Media player environment 202 also provides the software context within which media player 204 executes. Preferably, media player 204 is a “plug-in” to media player environment 202. Media player environment 202 and media player 204 work together to the extent that the user locates and requests a media stream with media player environment 202, and plays the media stream with media player 204. In the illustration of FIG. 2, media player 204 is depicted as a window in media player environment 202. In the preferred embodiment, media player environment 202 is a browser window, and media player 204 is a window for playing a media stream within the browser window. In an alternate embodiment, media client 110 may provide media player specific hardware and software for the execution of media player 204. An example of media player specific hardware is a PDA and PDA operating system that provides for the operation of media player 204.

Media player environment 202 also includes media stream selectors 206. Media stream selectors 206 allow a user to select between multiple media streams. In one embodiment of the present invention, media stream selectors 206 are icons, or other web page elements displayed in media player environment 202 “linking” to the network address of additional media streams. In a preferred embodiment of the present invention, media stream selectors 206 may additional instances of the media player playing other media streams available to the user. In some embodiments of the present invention, media stream selectors 206 play low resolution, and/or low frame rate media streams. In these embodiments, media stream selectors 206 may mimic a “picture-in-picture” function common among televisions.

According to the present invention, when the user selects one of media stream selectors 206, media player environment 202 seamlessly switches between playing the present media stream in media player 204 to playing a media stream corresponding to the selected media stream selector 206.

For example, the user may be watching a sporting event playing as a first media stream in media player 204. The first media stream may be a default camera coverage of the event, and media stream selector 206B may represent a second media stream from a camera mounted in a blimp over the field. When the user selects media stream selector 206B, media client 110 requests the second media stream. In conventional systems, when the user chooses to play a second media stream, play of the first media stream is interrupted or halted while the second media stream is acquired. Often times, the image in media player 204 is blank or frozen and remains so until the second media stream is acquired and begins playing. The present invention, however, provides a mechanism to ensure seamless switching from the first media stream to the second media stream.

Preferably, when the user selects one of media stream selectors 106, the corresponding media stream appears immediately in media player 204. However, due to various system constraints, particularly bandwidth constraints, a time delay exists between selecting media stream selector 106 and playing the corresponding media stream on media stream player 204.

One embodiment of the present invention accommodates this time delay by buffering one or more of the media streams. Accordingly, in one embodiment of the present

invention, media client 110 includes a media stream buffer. The media stream buffer decouples the portion of the media stream being played from the portion of the media stream being received so that media player 204 can continue to play one media stream while receiving the second stream during the time delay associated with the switch. In this embodiment, at least one of the media streams is buffered in the media stream buffer. When the user chooses to switch from the first media stream to the second media stream, media player 204 either plays one of the buffered media streams from the media stream buffer while the switch occurs, or buffers one of the media streams to the media stream buffer. In either case, this embodiment of the present invention ensures smooth, uninterrupted media stream play.

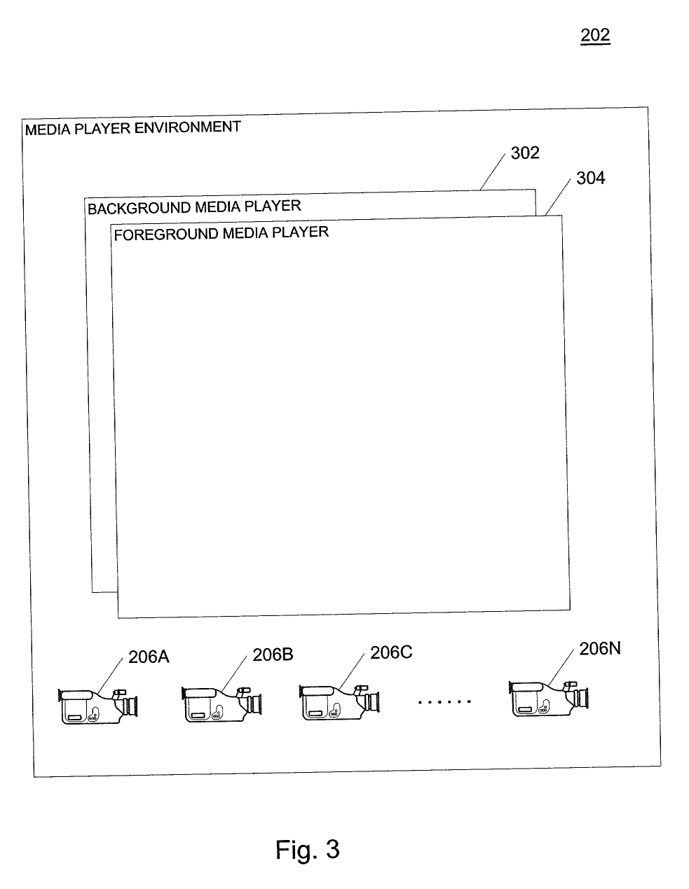

FIG. 3 illustrates media player environment 300 that seamlessly switches between multiple media streams according to one embodiment of the present invention. In this embodiment of the present invention, media player environment 300 includes a background media player 302, a foreground media player 304, and one or more media stream selectors 206. Preferably, each of background media player 302 and foreground media player 304 are instances of media player 204, as described above.

Preferably, media player 204 includes a media stream buffer. A media stream buffer stores a portion of the media stream so that media player 204 may play from the buffer. Commonly available media players, such as Microsoft® Windows Media Player®, Progressive Networks®, RealPlayer®, Apple Computer Corporation®, QuickTime® video player, etc., include media stream buffers. One of the reasons media player 204 includes a buffer is the asynchronous nature of network communications. The media stream may arrive over network 108 at an uneven rate, causing discontinuities in playing the media stream. The media stream buffer enables media player 204 to play the buffered portion of the media stream even in the absence of the media stream itself.

Preferably, media player 204 includes a number of media stream buffer controls, as is the case with commonly available media players. Buffer controls are software variables, events, and properties associated with the media stream buffer. For example, buffer controls may provide information about the state of the media stream buffer, such as the capacity, whether the buffer is empty or full, the amount of buffered media stream remaining, etc. Additionally, buffer controls may enable control of media stream buffer functions, such as emptying the buffer, changing the capacity of the buffer, etc.

In operation, foreground media player 304 plays a first media stream for the user. In the case of a video media stream, foreground media player 304 is displayed to the user by media player environment 300. While the foreground media player 304 is being displayed, background media player 302 is not discernable to the user. Background media player 302 may be, for example, layered under foreground media player 304, minimized, in a dormant state, or not yet instantiated. At some point, the user chooses to play a second media stream by selecting one of media stream selectors 206. Programming logic, such as JavaScript, HTML, VBScript, etc., causes media player environment 300 to send a request for the second media stream to media server 102.

During the time delay between sending the request, receiving the second media stream, and playing it for the user, foreground media player 304 continues to play the first media stream. In one embodiment of the present invention, foreground media player 304 plays the first media stream from a first media stream buffer, as described above. In these embodiments, the first media player may also continue to receive the first media stream after the request for the second media stream by action of media player environment 300 or by sending a request to media server 102 to stop streaming the first media stream.

For example, in one embodiment of the present invention, the request for the second media stream may be accompanied by a request from media player environment 300 to media server 102 to stop transmitting the first media stream. In these embodiments of the present invention, even though media client 110 stops receiving the first media stream, foreground media player 304 continues to play the first media stream from the media player buffer.

After receiving the request, media server 102 begins streaming the second media stream to media client 110. Background media player 302 receives and buffers the second media stream into its media stream buffer. Background media player 302 may buffer the second media stream before playing it, thereby ensuring media stream play, even if the second media stream from media client 110 is not continuous. At some point before the foreground media player 304 media stream buffer empties, program logic in media player environment 300 causes background media player 302 to replace foreground media player 304 in the web browser window.

There are a number of example methods to determine a point at which background media player 302 replaces foreground media player 304. One example is a point at which the media stream buffer of background media player 302 is full enough to begin playing the second media stream. At this point, background media player 302 would indicate, via an object, variable, or property, to media player environment 300 that the replacement should occur. Another example is a point at which the media stream buffer of foreground media player 304 is empty. Yet another example is at a particular index in either the first or second media stream. An index in the media stream identifies a particular point in time, such as a time index, or the file, such as a file index, in the media stream. Using an index into either of the media streams allows synchronization of switching from the first media stream to the second media stream. In yet another example, media player environment 300 may select a predetermined time period for which to buffer the second media stream. Once the predetermined time period has passed, buffering the second media stream is considered complete. Additionally, background media player 302 may monitor other programs, variables, methods, events, etc. to determine when buffering is complete.

According to one embodiment of the present invention, program logic determines when to replace foreground media player 304 with background media player 302. The program logic may monitor media stream buffer controls, time periods, file indices, etc. Examples of types of program logic that may be implemented are JavaScript, VBScript, applets, executables, downloadable components, etc. Preferably, the program logic such as JavaScript, HTML, etc. controls which of background media player 302 and foreground media player 304 are displayed to the user.

Background media player 302 may replace foreground media player 304 in a number of ways. In one embodiment, the order in which background media player 302 and foreground media player 304 are layered on the page is changed, and the page is refreshed with standard HTML and JavaScript techniques. In such a case, the background media player 302 is moved from behind foreground media player 304 and displayed to the user. Other techniques, such as windowing, layers, instantiation, etc., may be used to replace the foreground media player 304, as would be apparent. Preferably, the replacement is implemented in such a way that the user is aware of only a single media player, and is unaware that background media player 302 has replaced foreground media player 304.

Background media player 302 begins playing the second media stream concurrently with replacing foreground media player 304, thereby seamlessly switching between the first media stream and the second media stream so that the user experiences continuous playing of multimedia content.

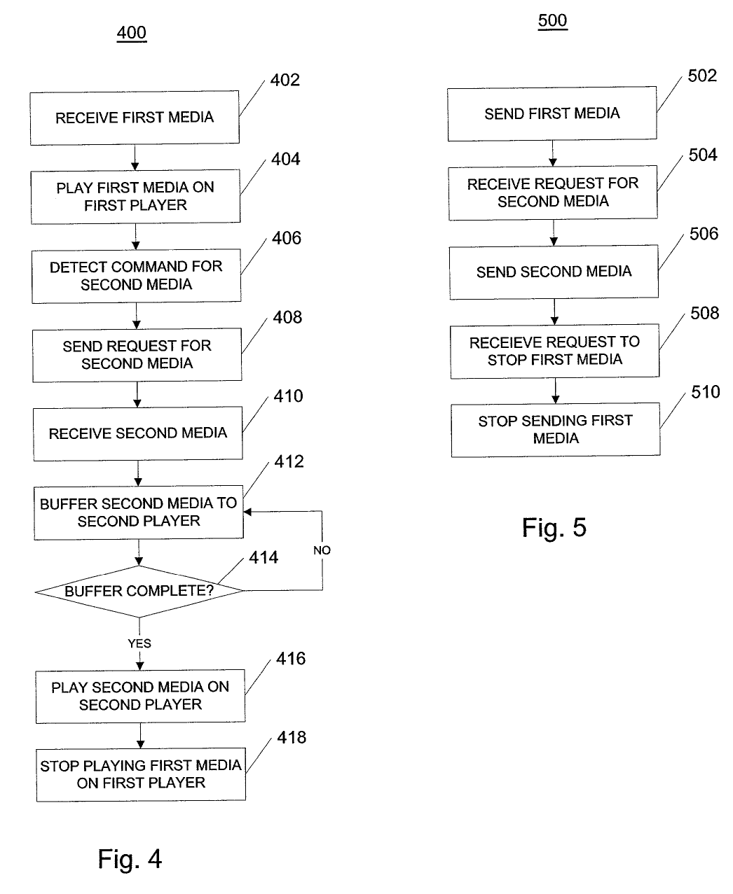

FIG. 4 illustrates an operation 400 that seamlessly switches between multiple media streams at media client 110. The process of operation 400 begins in a step 402. In step 402, media client 110 receives a first media stream.

In a step 404, the first media player on media client 110 begins playing the first media stream. While not illustrated in FIG. 5, media client 110 may buffer the first media stream to a media stream buffer, as discussed above. In this case, the foreground media player 304 may play the first media stream from the media stream buffer.

In a preferred embodiment, this first media player corresponds to foreground media player 304. At some point, in a step 406, media client 110 detects a command requesting a second media stream. Preferably, the command is generated by a user selecting an object in media player environment 202, such as one of media stream selectors 206. In an alternate embodiment, however, the command requesting the second media stream may be generated programmatically by other software on media client 110, media player environment 202, or other devices interacting with media client 110.

In a step 408, media client 110 sends a request for the second media stream to media server 102, via network 108. In a step 410, media client 110 begins receiving the second media stream from media server 102. In a step 412, a second media player begins to buffer the second media stream into a media player buffer. Preferably, the second media player buffering the media stream is background media player 302.

In decision step 414, background media player 302 determines if buffering step 412 is complete. As discussed above, there are a number of example mechanisms to determine whether buffering is complete and when and how background media player 302 replaces foreground media player 304.

In a step 416, background media player 302 begins playing the second media stream. In a preferred embodiment, the background media player 302 is brought forward in the media player environment and displayed to user 112. In a step 418, foreground media player 304 stops playing the first media stream, or alternately, runs to the end of the buffer.

FIG. 5 illustrates operation 500, a process for enabling seamless switching of multiple media streams at media server 102. The process of operation 500 begins in a step 502. In step 502, media server 102 begins streaming the first media stream to media client 110 via delivery layer 104 and network 108. Media server 102 may be streaming the first media stream in response to a request from media client 110, or as part of a normal operating procedure.

In a step 504, delivery layer 104 receives a request for a second media stream from media client 110. Preferably, the request identifies the network address of the second media stream.

In a step 506, media server 102 streams the second media stream to media client 110. In an optional step 508, media server 102 may receive a request from media client 110 to stop sending the first media stream. Preferably, the request to stop sending the first media stream indicates that the user at media client 110 intends to stop playing the first media stream, and it is no longer needed. Accordingly, in an optional step 510, media server 102 stops sending the first media stream.

While the invention has been described in detail and with reference to specific embodiments thereof, it will be apparent to one skilled in the art that various changes and modifications can be made therein without departing from the spirit and scope thereof. Thus, it is intended that the present invention cover the modifications and variations of this invention provided they come within the scope of the appended claims and their equivalents.

What is claimed is:

1. A method for seamlessly switching between media streams during playback, comprising:
receiving a first media stream;
playing said first media stream;
receiving a second media stream;
playing said second media stream; and
ending play of said first media stream after said playing said second media stream.

2. The method of claim 1, wherein said playing said first media stream comprises playing said first media stream via a first media player, and wherein said playing said second media stream comprises playing said second media stream via a second media player.

3. The method of claim 1, further comprising buffering at least one of said first media stream and said second media stream to a media stream buffer.

4. The method of claim 3, wherein said ending play of said first media stream comprises ending play of said first media stream when a predetermined amount of said at least one of said first media stream and said second stream is buffered in said media stream buffer.

5. The method of claim 1, wherein said ending play of said first media stream comprises ending play of said first media stream upon the occurrence of a predetermined event.

6. The method of claim 5, wherein said ending play of said first media stream comprises ending play of said first media stream upon a predetermined state of a media player buffer.

7. The method of claim 1, further comprising ending receipt of said first media stream before said playing said second media stream.

8. The method of claim 1, wherein said ending receipt of said first media stream comprises ending receipt of said first media stream before receiving said second media stream.

9. The method of claim 1, wherein said playing said second media stream comprises playing said second media stream beginning at an index point corresponding to said ending play of said first media stream.

10. The method of claim 9, wherein said playing said second media stream comprises playing said second media stream beginning at a file index in said first media stream corresponding to said ending play of said first media stream.

11. The method of claim 9, wherein said playing said second media stream comprises playing said second media stream beginning at a time index in said first media stream corresponding to said ending play of said first media stream.

12. A method for seamlessly switching between media streams during playback, comprising:
playing a first media stream;
detecting a request to play a second media stream;
beginning play of said second media stream; and
ending play of said first media stream after said beginning play of said second media stream.

13. The method of claim 12, wherein said playing a first media stream comprises playing a first media stream on a first media player, and further comprising playing said second media stream on a second media player.

14. The method of claim 12, further comprising buffering said second media stream in a second media stream buffer.

15. The method of claim 14, wherein said ending play of said first media stream comprises ending play of said first media stream when a predetermined amount of said second media stream is buffered in said second media stream buffer.

16. The method of claim 12, wherein said ending play of said first media stream comprises ending play of said first media stream upon an occurrence of a predetermined event.

17. The method of claim 12, further comprising buffering said first media stream in a first media stream buffer.

18. The method of claim 17, further comprises playing said first media stream from said first media stream buffer.

19. The method of claim 18, further comprising ending buffering of said first media stream prior to beginning play of said second media stream.

20. The method of claim 19, wherein said beginning play of said second media stream comprises beginning play of said second media stream before said first media stream buffer is empty.

21. A method for seamlessly switching between media streams during playback, comprising:
playing a first media stream via a first media player;
playing a second media stream via a second media player;
detecting a request to play said second media stream;
seamlessly switching from said first media player to said second media player in response to said request.

22. The method of claim 21, further comprising buffering said first media stream to a first media stream buffer.

23. The method of claim 22, wherein said playing a first media stream comprises playing said first media stream from said first media stream buffer.

24. The method of claim 21, further comprising buffering said second media stream to a second media stream buffer.

25. The method of claim 24, wherein said playing a second media stream comprises playing said second media stream from said second media stream buffer.

26. The method of claim 23, further comprising, upon detecting said request to play said second media stream:
ending buffering of said first media stream to said first media stream buffer; and
buffering said second media stream to a second media stream buffer;
wherein said playing said second media stream comprises playing said second media stream from said second media stream buffer.

27. The method of claim 26, where in said playing said second media stream from said second media stream buffer comprises playing said second media stream from said second media stream buffer before said first media stream buffer empties.

28. A method for enabling seamless switching between media streams during playback, comprising:
transmitting a first media stream to a media client;
receiving a request for a second media stream from said media client; and
transmitting said second media stream at a second media stream index corresponding with the point at which transmitting said first media stream is stopped.

29. A method for enabling seamlessly switching between media streams during playback, comprising:
buffering a first media stream;
playing said first buffered media stream;
seamlessly switching between playing said first buffered media stream and playing a second media stream.

30. The method of claim 29, further comprising buffering said second media stream while playing said first buffered media stream.

31. The method of claim 30, wherein said buffering a second media stream while playing said first buffered media stream comprises buffering a second media stream via a second media player while playing said first buffered media stream via a first media player.

32. A method for seamlessly switching between media streams comprising:
playing a first media stream;
buffering a second media stream while playing said first media stream;
seamlessly switching from playing said first media stream to playing said second media stream.

33. The method of claim 32, wherein said seamlessly switching from playing said first media stream to playing said second media stream comprises switching from playing said first media stream to playing said second media stream when said second media stream is fully buffered.

34. A media client environment comprising:
a foreground media player that buffers a first media stream and plays said buffered first media stream;
a background media player that buffers a second media stream and plays said buffered second media stream; and
a switch control that interchanges said foreground media player and said background media player to seamlessly switch between said first media stream and said second media stream.

35. A method for enabling seamless switching between media streams during playback, comprising:
buffering a first media stream;
playing said first media stream;
sending a request for a server to stop streaming said first media stream;
sending a request for a server to start streaming a second media stream;
buffering said second media stream; and
playing said first buffered media stream after said sending said request for a server to stop streaming said first media stream and while said buffering said second media stream.

36. A media client environment for seamlessly switching between media streams during playback, comprising:
a first media player;
a second media player; and
a media stream switch control for switching between said first media player and said second media player so that said second media player begins playing when said first media player stops playing.

37. A method for seamlessly switching between media streams during playback, comprising:
transmitting a first media stream to a first media player at a media client;
receiving a request for a second media stream from said media client;
transmitting said second media stream to a second media player at said media client; and
ending transmission of said first media stream to said media client when said transmitting said second media stream begins.
